(19) United States
(12) Patent Application Publication
(10) Pub. No.: US 2008/0092989 A1
(43) Pub. Date: Apr. 24, 2008

(54) Loading of a Veneer Slicer

(75) Inventors: Armin Heiner, Hohenroda (DE); Jean Meyer, Friedewald (DE); Heinrich Weppler, Ludwigsau (DE)

Correspondence Address: K.F. ROSS P.C., 5683 RIVERDALE AVENUE, SUITE 203 BOX 900, BRONX, NY, 10471-0900, US

(73) Assignee: GRENZEBACH BSH GMBH, Bad Hersfeld (DE)

(21) Appl. No.: 11/579,334

(22) PCT Filed: Mar. 2, 2005
(86) PCT No.: PCT/EP05/02172

§ 371 Date: Oct. 31, 2006

(30) Foreign Application Priority Data
May 21, 2004 (DE) 10 2004 025 181.9

(51) Int. Cl. B27L 5/04

(52) U.S. Cl. 144/363; 144/209.1

(57) ABSTRACT

The invention relates to a method and a device for loading a device for eccentrically slicing veneering. Known slicing devices are problematic in that the process for loading the same with a block of wood is relatively time-consuming and at least partly difficult to perform. The aim of the invention is thus to improve one such slicing device in such a way that the loading process is simplified and accelerated. To this end, a device for milling (2) grooves (3) comprises a measuring device (14) which is used to determine the cross-section of the block of wood (4); the position of the grooves (3) and the cross-section of the block of wood (4) can be recorded as data; and a grip device (17) and a tool carriage (5) of the slicing device (1) can be controlled according to the data in such a way that the block of wood (4) can be placed in the slicing device (1) and the tool carriage (5) is positioned in relation to the block of wood (4) in a starting position for the slicing. The invention also relates to the production of veneering.

The invention relates to a method and an apparatus for loading a machine for eccentrically cutting veneers from a flitch according to the preamble of claim 1.

Apparatuses used for eccentric cutting, also referred to as stay-log veneer machines, are used for cutting thin sheets from a flitch, which sheets are also referred to as veneers.

On stay-log veneer machines, the flitch is clamped on a planar support face of a beam. It is mounted rotatably about its horizontal longitudinal axis, so that with each revolution a veneer is cut off by a blade that is mounted parallel or at an acute angle to the longitudinal axis and that is movable toward the beam. Such a veneer machine is known, for example, from DE 102 61 918 C.

Upon completing a slicing operation, it is relatively work- and time-consuming to clamp in a new flitch. For this, the flitch, into which narrow grooves are milled in one longitudinal side, has to be positioned over the support face, for example with the help of hooks, and with the grooves fitted to retaining claws. The play between the retaining claws and the walls of the grooves is very small, thus making the clamping of a heavy, long flitch difficult and demanding much time.

Furthermore the blade has to be moved into the working position. The tool carriage has to be moved toward the flitch sufficiently far that the blade just barely contacts the flitch.

It is the object of the invention to simplify the loading of a veneer machine and shorten the work cycle, meaning the time from the end of one slicing operation to the beginning of the next.

The object is achieved with the features disclosed in independent claims 1 and 2. Due to the fact that in a miller the cross-sectional size of the flitch is determined, that the positions of the grooves and the cross-sectional size of the flitch are recorded as data, and that with the help of the data the flitch is placed in the apparatus and a blade is moved into a starting position, the operator has to manipulate the flitch only prior to milling and is relieved from any further, in part physically heavy work with the flitch. This way, the operator can better concentrate on the actual slicing process, which positively affects the quality of the veneers.

Furthermore, the time required for loading and start-up is reduced by up to 70%, and the productivity of the slicing machine is increased accordingly.

The dependent claims relate to the advantageous embodiment of the invention.

The invention will be explained further hereinafter with reference to an embodiment that is schematically illustrated in the drawing. Therein:

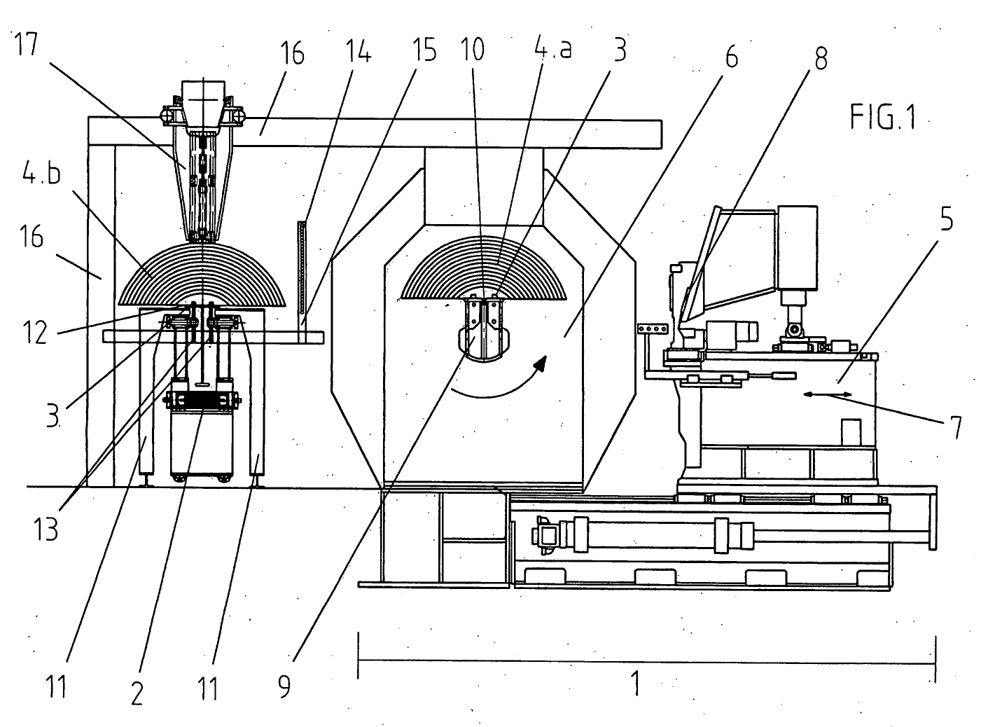

FIG. 1 is a side view of a loading apparatus according to the invention with a stay-log veneer machine, in a partially cut view, and

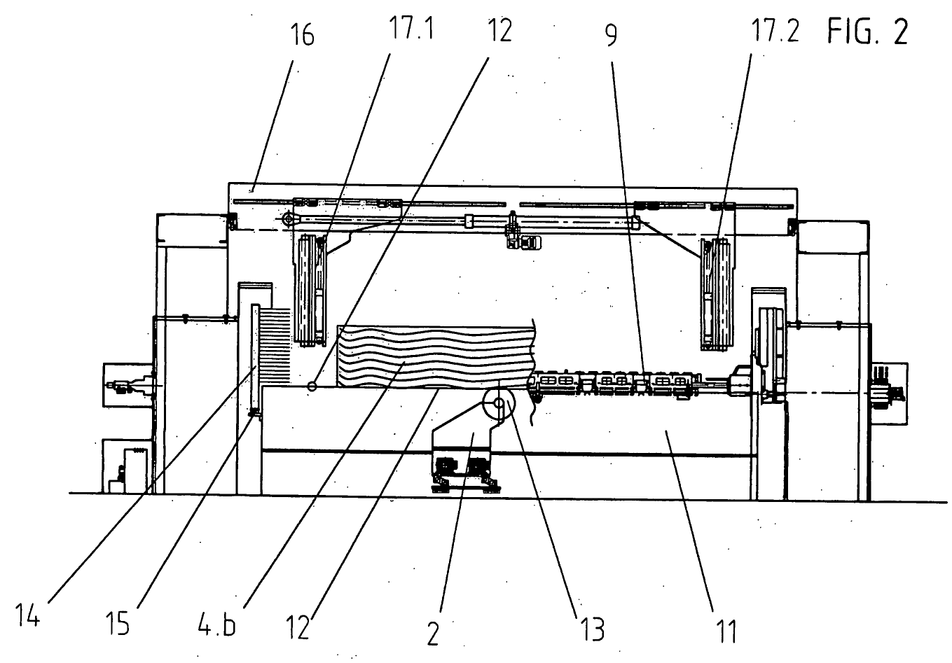

FIG. 2 is a side view perpendicular to the view according to FIG. 1 on the loading apparatus, in a partially cut view.

As illustrated in FIG. 1, a machine for eccentrically cutting veneers 1, in short a stay-log slicing machine 1, on a base frame, and a conventional miller 2 for cutting grooves 3 into a flitch 4 are set up adjacent each other.

The stay-log slicing machine 1 comprises in the known fashion a tool carriage 5 and a stay-log support 6. The tool carriage 5 with a blade 8 is movable in a horizontal plane so that it can shift back and forth as shown by an arrow 7. The stay-log support 6 is attached to the base frame such that a horizontal longitudinal axis of the beam 9 extends parallel to the blade 8. A flitch 4a can be clamped on a planar support face 10 of the beam 9.

Viewed from the tool carriage 5, the miller 2 is mounted on rails with two drivable milling tools 13 offset from the stay-log support 6, the miller being displaceable parallel to the beam 9. A table 11 is oriented relative to the displacement path of the miller 2 such that an upper table surface 12 is spaced beneath the upper plane defined by the milling tools 12 by a distance equal to the depth of the grooves 3. A cutout is provided in the table surface 12 parallel and preferably symmetrically to the longitudinal axis, so that the milling tools 13 can be displaced along this cutout. A planar face of another flitch 4b can be clamped on the table surface 12 in any random position with the help of clamps that are not shown.

On the side of the miller 2, a measuring apparatus 14 is mounted displaceably such that the cross-sectional size of the other flitch 4b can be determined. For this purpose, the measuring apparatus 14 can be displaced along a rail 15 transversely to the longitudinal axis of the table 11 with the help of a drive.

If the measuring apparatus 14 is a light curtain, for example, there is at one end of the miller 2 a transmitter, and at the other end there is a receiver, the transmitter and the receiver being displaced synchronously.

The miller 2 and the stay-log support 6 extend across a support frame 16, on which a grab 17 is horizontally displaceable. The grab 17 comprises two arms 17.1 and 17.2 that can be displaced vertically and parallel to the longitudinal axis of the table 11. Otherwise the grab 17 is substantially rigid.

The entire arrangement is connected to a central controller—for example a PLC (programmable logic controller) or a computer—that determines the processes of the miller 2, the loading apparatus and the stay-log slicing apparatus 1. During operation, the flitch 4a is clamped on the beam 9 and is sliced in the known manner.

During slicing, the other flitch 4b is positioned on the table surface 12 using suitable means and held in place by clamps. The drives of the milling tools 13 are turned on, and the miller 2 is displaced along the rails from one end position to the other end position. In so doing, the milling tools 13 produce the two parallel grooves 3. At the same time or subsequently, the measuring apparatus 14 is displaced steadily transversely to the longitudinal axis of the table 11 and in doing so the cross-sectional size of the other flitch 4b is determined and stored at least temporarily.

Thereafter, the clamps are loosened, and the grab 17 lifts the other flitch 4b off the table 11 and conveys it toward the stay-log support 6. The other flitch 4b is either moved into a waiting position between the miller 2 and the stay-log slicing apparatus 1 or—if no flitch 4a is clamped in the beam 9—it is set directly on the support face 10 of the beam 9, as will be described below.

These processes can be controlled semiautomatically or fully automatically, with the exception of the positioning operation.

Now a new flitch 4b can be positioned on the table 11, and the processes described above are repeated.

As soon as the flitch 4a has been sliced into veneers down to an unusable scrap, the tool carriage 5 is moved back into a starting position.

At the same time, the beam 9 is moved into a position in which the support face 10 is directed downward, and the flitch 4a is dropped.

Subsequently, the beam 10 is moved into a position in which the support face is directed upward to can receive the other flitch 4b. The grab 17 moves it onto the support face 10 precisely such that the clamping claws projecting from it fit into the grooves 3. The path that the grab 17 has to travel is known from the positions of the milling heads 13 and the support face 10 and is programmed accordingly, so that the other flitch 4b is set down automatically. At the same time, the tool carriage 5 is moved into a working position that is computed from the cross-sectional size of the other flitch 4b.

The grab 17 is moved into a waiting position so as to receive a further new flitch 4b as soon as it has been provided with the grooves 3.

These processes are then repeated.

1-4. (canceled)

5. A method of operating a veneer-making machine, the method comprising the steps of:
generally simultaneously
a) cutting veeners from a first flitch in a slicing station while clamping the first flitch at grooves cut into it by rotating the first flitch about an axis and shifting a blade radially inward relative to the axis in contact with the first flitch;
b) cutting grooves into a second flitch at a milling station adjacent the slicing station; and
c) measuring a cross-sectional size of the second flitch and storing measurements corresponding to the measured size; and
thereafter, when all the veneer is cut from the first flitch
d) shifting the blade radially outward away from the first flitch and removing the first flitch from the slicing station;
e) displacing the second flitch from the milling station to the slicing station and clamping it there by means of the grooves in the second flitch; and
f) shifting the blade radially inward toward the second flitch in accordance with the stored measurements of step c) and thereafter restarting at step a) with the second flitch.

6. A veneer-making machine comprising:
a beam extending along and rotatable about an axis at a slicing station;
clamps on the beam engageable in grooves in a first flitch and holding the first flitch on the beam;
a blade radially displaceable in the station relative to the beam;
drive means for rotating the beam with the first flitch clamped to it and for radially inwardly shifting the blade for cutting veneer from the first flitch;
means including cutters at a milling station spaced from the slicing station for cutting grooves into a second flitch;
means at the milling station for measuring a cross-sectional size of the second flitch in the second station and storing measurements corresponding to the measured size;
a grab shiftable between the stations; and
control means connected to the drive means, clamps, measuring means, and grab for
shifting the blade radially outward away from the first flitch and releasing the first flitch from the slicing station;
displacing the second flitch with the grab from the milling station to the slicing station and clamping it there by means of the grooves in the second flitch; and
shifting the blade radially inward toward the second flitch in accordance with the stored measurements and thereafter restarting rotation of the beam and shifting of the blade to cut veneer from the second flitch.

7. The machine defined in claim 6 wherein the milling station is immediately adjacent the slicing station.

8. The machine defined in claim 6 wherein the control means operates the grab to hold the second flitch in an intermediate waiting station between the milling station and slicing station.
